(19) United States
(12) Patent Application Publication
(10) Pub. No.: US 2009/0230572 A1
(43) Pub. Date: Sep. 17, 2009

(54) DRUM HUMIDIFIER WITH PIVOTING FLOOR

(76) Inventor: Donald N. Jursich, Crystal Lake, IL (US)

Correspondence Address: GREER, BURNS & CRAIN, 300 S WACKER DR, 25TH FLOOR, CHICAGO, IL, 60606, US

(21) Appl. No.: 12/048,710

(22) Filed: Mar. 14, 2008

(51) Int. Cl. B01F 3/04

(52) U.S. Cl. 261/70; 261/92; 261/DIG. 15

(57) ABSTRACT

A drum humidifier is designed for use with a forced air furnace and includes a housing including a base, a first side wall, a second side wall and a top. A removable water pan is positioned to be supported by the base. Water is maintained in the water pan by a watering means, the watering means comprising a float. A movable water pan floor, the water pan floor having an operating position and a maintenance position. The water pan floor is substantially coplanar with the base and is positioned under at least a portion of the water pan in the operating position. The water pan floor is moved to a maintenance position to allow removal of the water pan around a float while the water pan remains in a substantially horizontal position.

### BACKGROUND OF THE INVENTION

The present invention relates to a drum humidifier for adding moisture to unhumidified air. More specifically, it relates to an improved drum humidifier that allows the water pan to be removed while it maintains a horizontal position, reducing the opportunity of spilling the water.

Use of forced air systems for home heating is well known. A network of ducts is used to carry warm air throughout the home and return cool air to the furnace for reheating. Since cool air holds less moisture than warm air, household air that comes in contact with cool surfaces, such as windows, tends to condense a bit of the moisture, leaving the air dry. Dry air allows static electricity to build up, causing the familiar spark when people or pets touch conductive surfaces. If the dryness continues, moisture is drawn into the air from the skin and mucous membranes of the inhabitants or from wood products.

Adding moisture from a humidifier is a well known method of preventing dry skin, cracking and drying of furniture as well as making the environment more comfortable. Many types of humidifiers are known, including drum humidifiers. A drum humidifier has a hollow drum made of an evaporative element held on a substantially cylindrical frame. Rotation of the drum allows a portion of the evaporative element to come into contact with water that is absorbed. Unhumidified air from the furnace flows through the evaporative element, picking up moisture before the humidified air is returned to the furnace.

In a typical drum humidifier, water for absorption by the evaporative element is held in a water pan that rests on the base of the humidifier housing. A float on the surface of the water provides information as to when the water pan needs to be refilled. Traditionally, the float is positioned between the door of the housing and the drum. Since the float is necessarily on the water surface, it is lower than the height of the water pan walls. Thus, when the cover is opened and the water pan needs to be removed, the front edge of the pan has to be tipped downward to allow it to pass underneath the sensor. In this condition, the water is easily spilled.

Some prior art allows for movement of the float against a bias so for removal of the water pan and/or drum. The bias or spring encourages the float to return to its ready position without effort on the part of the user. However, in this type of humidifier, the user must hold the float out of the way with one hand while removing the pan with the other hand. In this situation, it is easy to tip the water pan, again resulting in spillage.

Thus, there is a need in the art for a way of removing the water pan of a drum humidifier without spilling the water, even when working in tight or awkward places.

### SUMMARY OF THE INVENTION

These and other needs are met or exceeded by the drum humidifier of the present invention. More specifically, the drum humidifier simplifies the process of removing the water pan from the humidifier housing by allowing a portion of the floor to pivot downwards so that the water pan can be removed from the housing around the float assembly with a low likelihood of spilling the water.

The drum humidifier is designed for use with a forced air furnace and includes a housing including a base, a first side wall, a second side wall and a top. A removable water pan is positioned to be supported by the base. Water is maintained in the water pan by a watering means, the watering means comprising a float. A movable water pan floor, the water pan floor having an operating position and a maintenance position. The water pan floor is substantially coplanar with the base and is positioned under at least a portion of the water pan in the operating position. The water pan floor is moved to a maintenance position to allow removal of the water pan around a float while the water pan remains in a substantially horizontal position.

A drum is included within the humidifier having an evaporative element, and is positioned to draw water from the water pan. The drum is turned using a rotating means.

The pivoting floor of the present drum humidifier simplifies removal of the water pan from the housing without water spillage. Instead of requiring that the water pan be siphoned, pulled forward and tipped to remove it, it can be pulled forward and lowered vertically without having to drain the water. This allows movement of the sides of the water pan around the float assembly without the need to tip the water pan from a substantially horizontal plane.

### DETAILED DESCRIPTION OF THE DRAWINGS

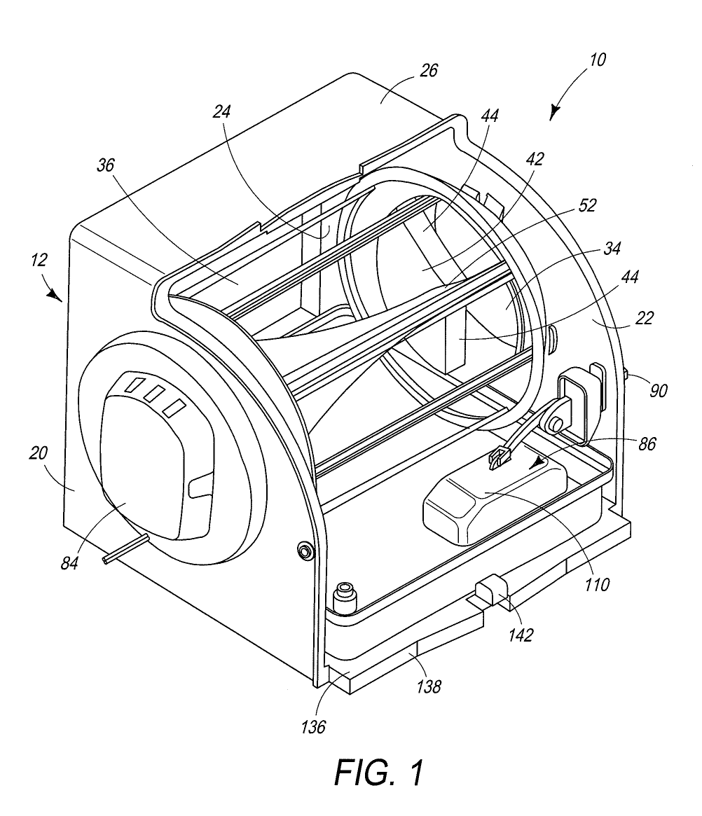

FIG. 1 is a left perspective view of the drum humidifier of the present invention; showing the cover removed for clarity;

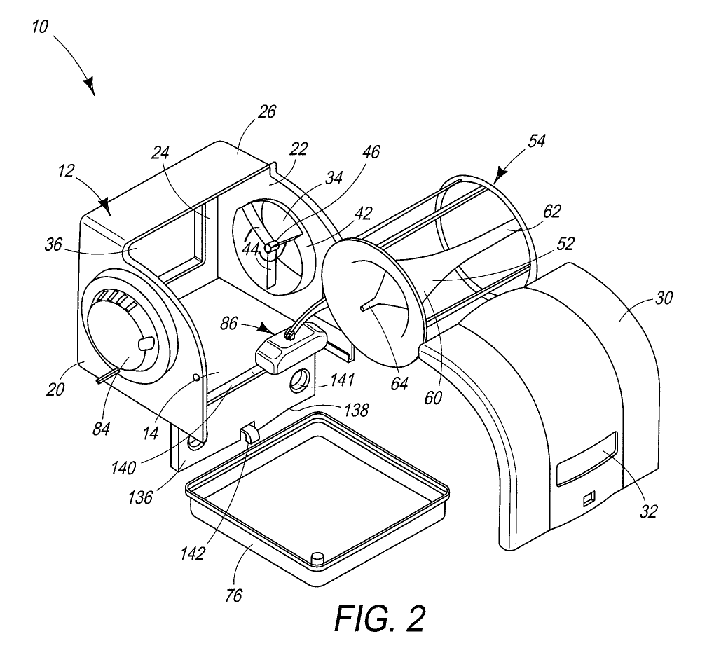

FIG. 2 is a left perspective, exploded view of the drum humidifier of FIG. 1;

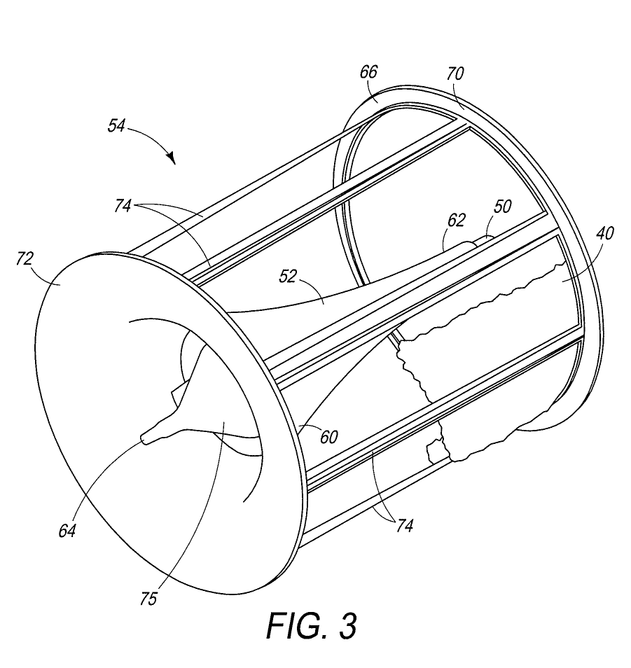

FIG. 3 is an elevated, perspective view of the drum of the drum humidifier of FIG. 1;

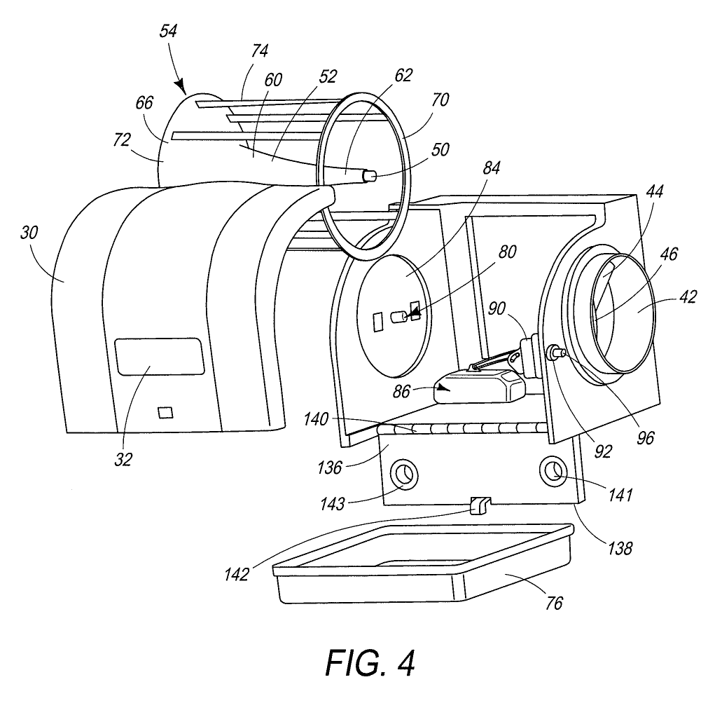

FIG. 4 is a right perspective, exploded view of the drum humidifier of FIG. 1;

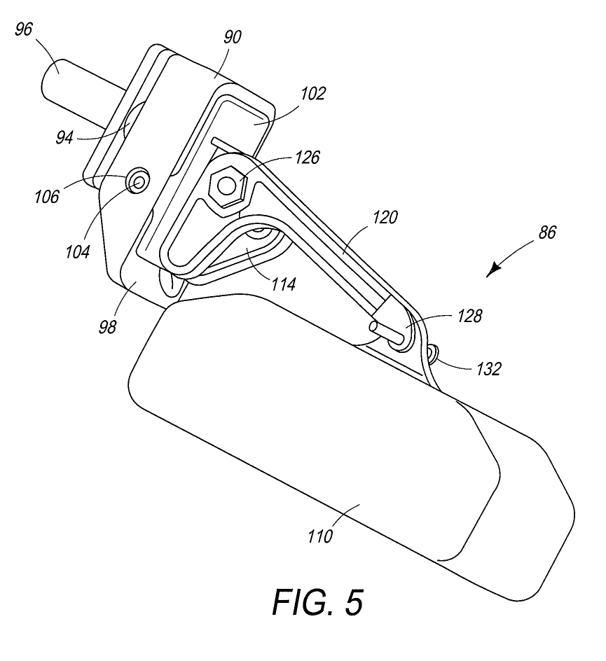

FIG. 5 is an elevated perspective view of the float assembly of the drum humidifier of FIG. 1; and

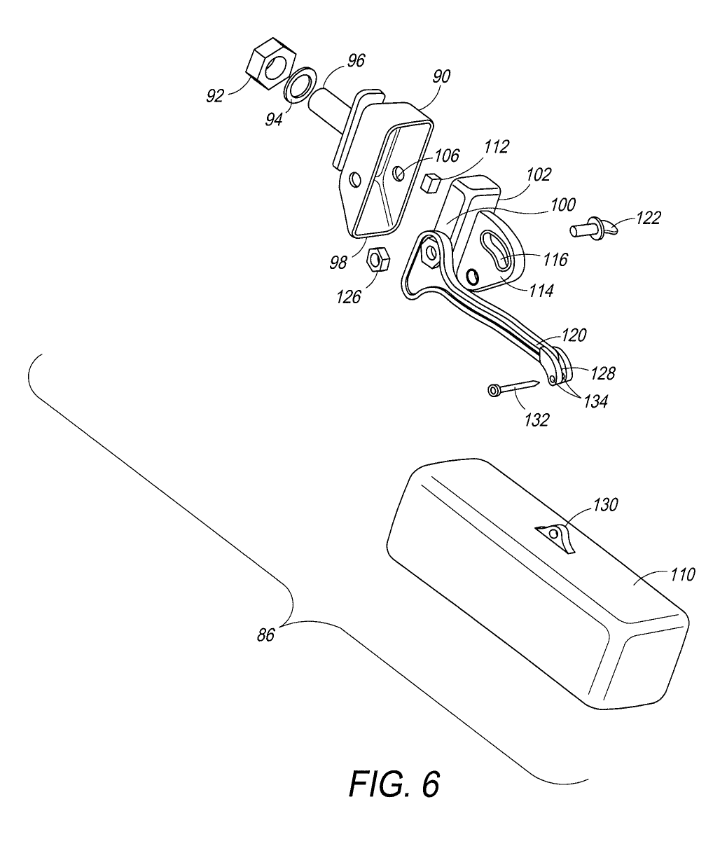

FIG. 6 is an exploded, perspective view of the float assembly of the drum humidifier.

### DETAILED DESCRIPTION OF THE INVENTION

Referring to FIG. 1, a drum humidifier, generally 10, is shown for use with a forced air furnace (not shown). Unless otherwise noted, parts of the drum humidifier 10 are made of materials that hold their shape, withstand temperatures within the air ducts of a furnace, and will not mold or rust in the presence of warm, moist air. Preferred embodiments of the drum humidifier are made of thermoplastics or of rust-free metals, such as aluminum. All references to the relative positions of various features are to be interpreted as if the humidifier 10 is oriented as shown in FIG. 1.

The drum humidifier 10 includes a housing, generally 12, that serves to contain its features, direct air flow and to provide an aesthetically pleasing appearance to the exterior of the humidifier. Components of the house 12 include a base 14, a first side wall 20, a second side wall 22, an optional back wall 24 and a top 26. The first and second side walls 20, 22 are positioned between the base 14 and the top 26 of the housing 12 opposing each other.

A cover 30 is configured and adapted to cover the front of the humidifier housing 12. This allows access to the humidifier 10 when maintenance is needed. The cover 30 is openable to the top or either side. It is also contemplated that the cover be reconfigurable by the user, since the availability of space between one furnace and another is variable. Where a cover 30 opening to one side may provide the easiest access in some embodiments, in other embodiments it may be more advantageous to have a door that swings upward or to the other side. The cover 30 optionally includes a window or lens 32 to view inside the humidifier 10.

As shown in FIG. 2, the door 30 has a curved shape, however it is contemplated that the door 30 be of any shape as long as it fits the shape of the housing 12 and it helps to direct air flow from an air inlet 34 to an air outlet 36. The air outlet 36 is an opening cut into the back 24 of the housing 12. Unhumidified air flows from the air inlet 34 into the housing 12. Once inside the housing 12, the air passes through an evaporative element 40 and becomes humidified air. Humidified air is directed toward the air outlet 36.

Although this description assumes that air enters the unit through side wall 22 and exits through the back 24 of the housing, it is to be understood that it is equally suitable for air to enter through the back 24 of the humidifier 10, and exit through the side wall 22. Air will flow from areas of high pressure to areas of low pressure. If the back 24 of the humidifier 10 is attached to a high pressure duct of the furnace, such as the hot air duct exiting the furnace, and the air exiting the humidifier 10 is fed to a lower pressure duct, such as a cold air return, than the air will flow in from the back 24 and out the side wall 22. If the back 22 is attached to a low pressure duct and the side wall gets air from a higher pressure duct, then the air will flow as described below. The humidifier 10 can be installed either way, giving the installer some flexibility in where to place the unit.

A collar 42 is inserted into the second side 22 of the housing 12. The collar 42 includes a plurality of blades 44 that position a center 46 support for receiving a first axle 50. This support keeps a drum shaft 52 approximately coaxial with a drum, generally 54. The collar 42 also serves effectively as the air inlet 34 for the humidifier 10, with dry air entering the humidifier 12 between the blades 44 of the collar 42. Any number of blades 44 can be used. Additional blades 44 provide progressively less additional support and reduce the amount of incoming air since there are additional friction surfaces over which the incoming air must pass. Where needed, an extension duct (not shown) can be attached to the collar 42 to carry air from a furnace duct to the humidifier 10 to the air inlet 34.

Referring to FIGS. 2 and 3, the air inlet 34 is positioned in the second side wall 22 of the housing 12. In this embodiment, the drum 54 is positioned between the first side wall 20 and a second side wall 22. The funnel-shaped drum shaft 52 has a wide end 60 and a narrow end 62, where the narrow end is closest to the second side wall 22. The first axle 50 and a second axle 64 protrudes from the shaft 52 at each end 60, 62, each axle 50, 64 substantially being coaxial with the shaft 52 itself. The first axle 50 at the narrow end 62 of the shaft 52 while the second axle 64 is positioned at the wide end 60 of the shaft 52. The drum 54 is open to the flow of unhumidified air at the narrow end 62 and closed to the flow of unhumidified air at the wide end 60 of the drum shaft 52.

A drum body 66 is substantially coaxial with the shaft 52, supporting it and holding it in place. The drum body 66 includes two coaxial rims, a first rim 70 and a second rim 72, that are connected to each other with a plurality of ribs 74. Each of the ribs 74 is approximately the same length, from the first rim 70 to the second rim 72. From the end of the drum body 66 closest to the second side wall 22 and moving inwardly along a radius, the drum shaft 52 tapers from the axle 50 to the second rim 72, in a continuous frusto-conical shape. From the second axle 64 and continuing to move inwardly along a radius, a second cone-shaped section 75 is formed. This second cone-shaped section 75 tapers from its intersection with the drum shaft to the second axle 64. The second axle 64 engages with the motor 80 to turn the drum, keeping it moist with water.

The drum 54 supports one or more of the evaporative elements 40. More specifically, the plurality of ribs 74 is used to support the evaporative element 40. The exact number of ribs 74 varies with the diameter of the drum 54 and the weight of the evaporative element 40, particularly when wet. One preferred embodiment includes about six ribs 74, however, the number of ribs 74 can vary depending on the exact evaporative material used and its weight when wet. Preferred embodiments of the drum 54 include an even number of ribs 74. This allows the sheet of evaporative material 40 to be woven over and under the ribs 74 with both ends of the sheet meeting on the same side of the ribs 74.

The evaporative element 40 can be made of any material that can absorb water when dipped into a water pan 76. Preferred embodiments of the evaporative element 40 use a thin foam or cellular material that absorbs water as it passes through the water pan 76. An example of a preferred cellular material 60 is reticulated ether-based polyurethane foam. Any type of evaporative material 40 as is known in the art can be used in this humidifier 10. If paper is used, a greater number of ribs 74 may be needed to control sag of the evaporative element 40. Sturdier evaporative materials, such as slit and expanded metals, may require fewer ribs 74.

As discussed above, the drum shaft 52 has a conical shape. The diameter of the drum shaft 52 expands when moving axially along the drum shaft from the first axle 50 to the drum body 66. Most of the air flowing into the drum 54 initially moves approximately parallel to the drum axis. As the air comes in contact with the drum shaft 52, it is deflected outward by the funnel shape toward the evaporative element 40. The gradual increase in diameter distributes the deflected air along the length of the evaporative element 40 so that a large portion of the evaporative element 40 surface has dry air moving through it. In this manner, a substantial portion of the evaporative element 40 is effectively utilized to distribute water.

The drum 54 is supported between the rotating means 80 in the first side wall 20 and the collar 42 in the second side wall 22. The second axle 64 is inserted into the center support 46 in collar 42 in the second side wall 22. A rotating means 80 is mounted through a mounting plate 82 attached to the interior of the first side wall 20. In a preferred embodiment, the rotating means 80 is an electric motor designed to slowly turn the drum 54. As the dry air passes through the evaporative element 40, moisture is depleted from the evaporative element 40 as it is entrained in the air. The radius of the drum 54 is designed to be greater than an altitude from the surface of water in a water pan 76 to the drum axis. This ensures that the evaporative element 40 is wetted by the water, continuously rotating the evaporative element 40 to wet substantially the entire surface. Optimally, the rotating means 80 rotates the drum 54 at a speed whereby the drying time of the evaporative element 40 is substantially the same as the time of one revolution of the drum 54. A motor cover 84 mounted to the exterior of the first side wall 20 covers the rotating means 80.

The base 14 of the housing acts to support the removable water pan 76 positioned thereon. The water pan 76 is sized and configured to hold water that is picked up by the evaporative element 40. The drum humidifier 10 could be designed to accommodate any size or shape of water pan 76. Practically, the water pan 76 accommodates the entire width of the drum 54 in order to wet the evaporative element 40. The humidifier 10 is mounted to the ductwork of the furnace. The ductwork is not designed to hold a great weight mounted thereto. It is generally not practical to make the capacity of the water pan 76 in excess of one gallon due to the weight of the water that would result if the pan were filled to capacity. In a preferred embodiment, the capacity of the water pan 76 is approximately one-half gallon.

In a preferred embodiment, it is preferable to refill the water pan 76 at frequent intervals rather than have a large, heavy water pan 76. Another element of the humidifier 10 is a filling means for maintaining water in said water pan. A float assembly, generally 86, is designed for this purpose. Referring to FIGS. 5 and 6, the float assembly 86 having an orifice 90 is mounted through the second side wall 22. In one embodiment it is mounted using a mounting nut 92 and optionally cushioned with a flexible pad 94. The portion of the orifice 90 extending through the second side wall 22 is a water supply 96 to furnish water with which to refill the water pan 76. A discharge 98 is shaped into the bottom of the orifice 90 through which the water enters the humidifier 10 and the water pan 76.

The orifice 90 is configured to hold a pair of legs 100 on a water feed plate 102. At least one pivot pin 104 passes through the orifice 90 such that the legs 100 pivot within the orifice 90. It is contemplated that the pivot pin 104 can be a single pin that passes through both the orifice 90 and the legs 100, or it can be a pin integral to each of the pair of legs 100 that extends through a pair of openings 106 in the orifice 90. Any pivot mechanism 104 can be used that allows movement of the water feed plate 102 with respect to the orifice 90. The legs 100 are further configured to allow the pivoting motion of the water feed plate 102. Whatever pivot mechanism 104 is used, it should be sufficiently flexible so as to allow a float 110 determine the position of the water feed plate 102, but not have the water feed plate 102 holding the float 110 above or below the surface of the water.

Between the legs 100 and facing the orifice 90, the water feed plate 102 has a stopper 112 that acts as a valve to stop the flow of water when the water feed plate 102 is in an upright position. In this position, the top of the legs 100 are in contact with the orifice 90. The stopper 112 is positioned to fit into the water supply 96 to block flow of water into the water pan 76 when it is sufficiently full to wet the evaporative element 40. However, as the water feed plate 102 pivots, the tops of the legs 100 loose contact with the orifice 90 and the stopper 112 is pulled away from the water supply 96. Sufficient movement of the water feed plate 102 frees the stopper 112 from the water supply 96, allowing flow of water through the discharge 98 to the water pan 76.

Included on the water feed plate 102 is a tab 114 that extends normally to the plate opposing the legs 100. The tab 114 has a slot 116 that is used to attach a float arm 120 to the water feed plate 102. A thumbscrew 122 fits through the slot 116, then into a first aperture 124 in the float arm 120. A nut 126 secures the thumbscrew 122, preventing slippage between the water feed plate 102 and the float arm 120. At an end 128 of the float arm 120 opposite the water feed plate 102 is a float 110. It is contemplated that the float 110 be attached to the float arm 120 by any known means. One preferred method is by use of a cotter pin 132 through at least one second aperture 134 in the float arm 120 and through an orifice 130 in the float 110. Preferably the cotter pin 132 is secured through a pair of second apertures 134 with the orifice 130 sandwiched between the second apertures 134.

The float 110 floats on the surface of the water in the water pan 76, ranging from an upper position to a lower position. In the upper position, the water in the water pan 76 is sufficiently deep to easily wet the evaporative element 40 as it is rotated through the pan. When in the upper position, the stopper 112 is fully engaged in the water supply 96 so that no water enters the drum humidifier 10. If the float 110 is in the lower position, the water in the water pan 76 has become depleted and it is desirable to add water thereto. As the float 110 moves from the upper position to the lower position, the float 110 draws the float arm 120 downward with it. Downward movement of the float arm 120 causes the water feed plate 102 to pivot, slowly pulling the stopper 112 from the water supply 96. Further movement of the float 110 to the lower position eventually pulls the stopper 112 from the water supply 96, allowing flow of water to the water pan 76. Addition of water then causes the float 130 to begin to rise, pushing the float 110 and float arm 120 upwards. As the water feed plate 120 pivots in the opposite direction, the stopper 112 is slowly pushed into the water supply 96, decreasing the flow of water. At the upper position, the stopper 112 is fully engaged in the water supply 96 so that no water flows into the water pan 76.

Referring to FIGS. 1, 2 and 4, a water pan floor 136 allows the water pan 76 to be removed from the housing 12 with reduced chance of spilling it. The water pan floor 136 moves from being in an operating position to a maintenance position. While humidified air is being introduced to the furnace, the water pan floor 136 is in the operating position. In this position, the water pan floor 136 is substantially coplanar with the base 14. It is also positioned to be under at least a portion of the water pan 76. When humidity is called for, the evaporative element 40 rotates on the drum 54 so that a portion of the evaporative element 40 is in contact with the water. The evaporative element 40 picks up water from the water pan 76, depleting the amount of water therein.

However, when the evaporative element 40 needs to be changed, or other maintenance needs to be done, it is necessary to remove the water pan 76. At this time, the water pan floor 136 is moved to the maintenance position. In the maintenance position, the water pan floor 136 is no longer substantially coplanar with the housing base 74. The water pan floor 136 moves to a position that allows removal of the water pan 76 around the float 110 while said water pan 76 remains in a substantially horizontal position.

The water pan floor 136 can be moved to a variety of positions. Preferably, the water pan floor 136 is pivotally attached to the housing base 14. This arrangement allows it to pivot on so that an edge 138 opposing a pivot 140 swings downward, away from the plane of the housing base 14. To allow the water pan 76 to pass through the resulting opening in a substantially horizontal position, the opposing edge 138 should rotate at least 90° from the housing base plane. In some embodiments, the opposing edge 138 of the water pan floor 136 rotates from about 90° up to 180° from its position substantially parallel to the housing base plane. The water pan floor 136 is “substantially coplanar” with the housing base if, while resting on the surface created by the base 14 and the water pan floor 136 in the operating position, there is no spillage of water when the water pan 76 fills with water to the level of the float 110 in the upper position. Optionally, the water pan floor includes one or more drain holes 141, each of which includes a drain spout 143.

Change in position from the operating position to the maintenance position is initiated by release of the water pan floor 136 from the operating position. The water pan floor 136 is held in the operating position by a latch 142. One of the group consisting of the cover 30, the housing 12 or both secures the water pan 76 floor during operation. When maintenance begins that requires removal of the water pan 76, the latch 142 is released. In some embodiments, the water pan floor 136 is releasably attached by the latch 142 to the housing cover 30. In these embodiments, release of the latch 142 also releases the housing cover 30 allowing it to open substantially simultaneously with the movement of the water pan floor 136.

It is also contemplated that in some embodiments, the water pan floor 136 will optionally be held in place in the maintenance position by the latch 142 that removably attaches it to the housing base 114, first side wall 20 or second side wall 22. This feature holds the water pan floor 136 out of the path to be traveled by the water pan 76 while removing it for maintenance. Suitable latches 142 include magnetic latches, push latches and friction latches.

While a particular embodiment of the catalyst for the set acceleration of spray applied plaster has been shown and described, it will be appreciated by those skilled in the art that changes and modifications may be made thereto without departing from the invention in its broader aspects and as set forth in the following claims.

What is claimed is:

1. A drum humidifier for use with a forced air furnace, said humidifier comprising:
a housing including a base, a first side wall, a second side wall and a top;
a removable water pan positioned to be at least partially supported by said base;
a watering means for maintaining water in said water pan, said watering means comprising a float;
a movable water pan floor, said water pan floor having an operating position and a maintenance position, said water pan floor being substantially coplanar with said base and being positioned under at least a portion of said water pan in said operating position and said water pan floor being moved to a maintenance position to allow removal of said water pan around a float while said water pan remains in a substantially horizontal position;
a drum including an evaporative element, positioned to draw water from said water pan; and
a rotating means for turning said drum.

2. The humidifier of claim 1 wherein said water pan floor is pivotally attached to said base.

3. The humidifier of claim 1 further comprising a latch for release of said water pan floor.

4. The humidifier of claim 1 wherein said drum is supported between said first side wall and said second side wall.

5. The humidifier of claim 1 wherein said rotating means comprises a motor.

6. The humidifier of claim 1 wherein said drum further comprises supports for said evaporative element.

7. The humidifier of claim 1 wherein said drum further comprises a first axial end that is open to the flow of air and a second axial end that is closed to the flow of air.

8. The humidifier of claim 1 further comprising a collar within said first axial end, wherein said collar is configured and arranged for permitting the humidified air to pass therethrough.

9. The humidifier of claim 1 wherein said water pan floor further comprises one or more drain holes, each said drain hole having a drain spout.

10. The humidifier of claim 5 wherein said housing further comprising a motor cover.

11. A method of maintaining a dehumidifier having an evaporative element rotatable on a drum removes water from a water pan, said method comprising:
opening a door, said door being movably connected to a housing, said housing having a rear panel defining an air inlet, a base and a plurality of sides;
controlling the addition of water to the water pan;
altering the position of a water pan floor from an operating position to a maintenance position, said water pan floor being substantially co-planar with a base of said housing in said operating position and the water pan floor being moved to a position that allows removal of said water pan around the float such that the water pan is removable while maintaining a horizontal orientation;
moving the water pan along the base away from the rear panel; and
lowering the water pan through the opening created by altering the position of the water pan floor while maintaining the water pan in a substantially horizontal position.

12. The method of claim 11 further comprising pivoting the water pan floor to alter it between the operating position and the maintenance position.

13. The method of claim 11 further comprising rotating a drum comprising an evaporative element and contacting the evaporative element with water in the water pan.

14. The method of claim 11 further comprising latching the water pan floor to hold it in the operating position.

15. The method of claim 11 further comprising positioning a float on the surface of water in the water pan and controlling the level of the water with the float.
